(19) United States
(12) Patent Application Publication
(10) Pub. No.: US 2011/0125677 A1
(43) Pub. Date: May 26, 2011

(54) Decorated Products

(76) Inventors: Janette Suh Edelstein, Belle Mead, NJ (US); Karin Taylor, New York, NY (US); Maria Isabel Carrizales, New York, NY (US)

(21) Appl. No.: 12/951,522

(22) Filed: Nov. 22, 2010

Related U.S. Application Data
(60) Provisional application No. 61/263,623, filed on Nov. 23, 2009.

(51) Int. Cl. G06Q 90/00; A46B 9/04; B65D 85/00; B23P 19/04

(52) U.S. Cl. 705/500; 15/167.1; 206/361; 29/700

(57) ABSTRACT

Decorated products, such as toothbrushes, of substantially the same type and having substantially the same features (preferably functional features) except for a decorative element. The decorative element on each product is selected from a plurality of different decorative elements such that the products may be visually or aesthetically differentiated from one another by the differences in the decorative element associated therewith, while otherwise having the same functional characteristics. An exemplary embodiment is sleeved adult toothbrushes, the sleeves each having one of a variety of designs, the set of available designs including designs of different categories to appeal to different consumer bases (e.g., different ages, genders, styles, etc.) or to signal a time period for use of the product (e.g., a variety of designs for each of the four seasons to signal changing the toothbrush each season). Preferably, the products are decorated with a design selected from more than one category of designs, at least two of which categories include more than one design. The designs may be changed for the product line on a regular or semi-regular basis to refresh the appearance of the products.

### CROSS-REFERENCE TO RELATED APPLICATION

The present application claims the benefit of the earlier filing date of U.S. provisional application 61/263,623, filed Nov. 23, 2009, which application is incorporated by reference herein in its entirety.

### FIELD OF THE INVENTION

The present invention is directed to decorated products. More particularly, the present invention is directed to a product line of products of substantially the same type and having substantially the same features except for a decorative element, the decorative element on each product being selected from a plurality of different decorative elements such that the products may be visually or aesthetically differentiated from one another by the differences in the decorative element associated therewith.

### BACKGROUND OF THE INVENTION

Manufacturers have an ongoing desire to sell products with multiple decorative designs to attract as wide a range of customers as possible. Generally, manufacturers have a concurrent desire to supply a multitude of decorative designs that are aesthetically pleasing to the eye of the customer. Manufacturers also have an ongoing desire to change/update/refresh the look of a product as often as possible (such as to encourage renewed and ongoing interest in purchasing new products). They would also like to be able to provide such variety in an economic manner, and allow for continuously changing inventory (thereby continuously attracting consumer interest) in an economic manner.

Various methods of decorating products such as personal grooming products (e.g., toothbrushes) are known in the art. Methods that have been used include preparing the product in a two step process with different colored materials, affixing decals to the product, and heat-shrinking a tubular film over a portion of the product. In the two step process, the product body is formed out of a first material (e.g., polypropylene) in a first injection molding step, and a second material (e.g., a thermoplastic elastomer, a polypropylene with a different property such as a different color, ABS, copolyesters, etc.) is injected around the first-formed body in a second molding step. This method permits the decorative element to completely circumscribe the perimeter of the product body. However, the two step process requires more costly molds and raw materials and more intricate processing. Another disadvantage of this method is that the decorative element is produced by the mold body, and changing the decorative element requires a costly change in the mold. This would not enable manufacturers to make change and sell products with multiple patterns cheaply. Another manner of decorating products involves affixing decals to the product. However, such method generally does not permit the positioning of decorative elements about the entire product. In addition, the decorated elements generally are not especially durable and may wear away or fall off. Also, proper alignment of the decal on the product generally is important if not essential to the overall appearance of the decorated product. Another method of decorating products is to heat-shrink a plastic film in tubular form having a decorative pattern to conform to the product shape. Virtually a limitless number of motifs may be applied using a heat-shrink process.

There has been a growing demand for decorated consumer products, such as for personalizing or to make the product more fashionable and/or decorative (such as following interior design trends to improve the product's look in use in the consumer's home and/or to follow the décor of the room). For instance, consumers have become accustomed to personalizing personal articles such as cellular telephones (e.g., by selecting a faceplate or “skin” or other type of covering or decoration for the telephone) as a mode of expression. Disposable lighters have been sold with a variety of decorative sleeves so the consumer can select a desired pattern or design as a form of self-expression. Even shavers, such as the Schick Silk Effects Plus shavers (at the time, sold by Warner-Lambert), have been sold with one of a plurality of decorative designs on the handle thereof. Other types of consumer products have been sold in one of a plurality of decorative patterns, such as Envirosax re-usable tote bags (www.envirosax.com), which are decorated in one of a variety of different themes, each theme having a plurality of tote bags with one of a plurality of different related patterns. Various consumer product packagings have been available in different colors and/or patterns, such as facial tissue boxes (such as the Kleenex Expressions boxes sold by Kimberly-Clark), disinfecting wipes containers (such as the Clorox Décor Canisters sold by the Clorox Company), liquid soap bottles (such as the Soft Soap Ensembles collection sold by Colgate-Palmolive), and even sanitary napkin packaging (decorated individual wrappers or decorative boxes for holding a plurality of panty liners). However, the choices for self-expression in connection with various disposable products, such as personal grooming products (toothbrushes, hairbrushes, combs, razors) and pens, are generally limited to color choice. Although a majority of consumers have been found to choose a product by color, additional choices would be desirable. Moreover, although children's products such as toothbrushes have been decorated with various designs (such as animals or licensed characters), adult products generally have not offered such choices, and no adult decorated toothbrushes have been known to be offered. Heretofore, the only variations available for a given toothbrush geometry have been in the color or colors of the components of the toothbrush handle or bristles.

Various products, particularly personal grooming products associated with hygienic routines, should be replaced on a regular basis, thus requiring regular purchase of replacements. For instance, regular brushing of the teeth is a fundamental requirement of proper oral hygiene, and regular replacement of toothbrushes is required to affect proper cleaning (particular in view of the natural wearing down of the bristles). It is generally recognized that it is difficult to achieve compliance with such regimens. Manufacturers have long recognized the need not only to attract users to use their toothbrushes, but also to encourage replacement and purchase of new toothbrushes on a regular basis.

In addition, manufacturers have recognized the benefit of providing replacement reminders as an inherent part of products that wear out and need to be replaced on a regular basis. For instance, toothbrushes have been provided with indicators, such as color changing bristles, to remind the user to replace the toothbrush with a new toothbrush on a regular basis.

### SUMMARY OF THE INVENTION

The present invention relates to product lines of products, such as personal grooming devices, which are decorated with one of a variety of decorative elements that can be manufactured inexpensively, are aesthetically pleasing to the eye of the customer, and are available in a virtually limitless number of patterns and motifs. Another aspect of the present invention may provide the user with an indication that the user should replace the product with a new product.

In accordance with principles of the present invention, a relatively inexpensive manner of decorating products of a product line is provided such that not only a plurality of differently decorated products may be manufactured and sold at the same time under a given product line, but also the decoration of the products can be readily changed or updated to impart a fresh look to the product line.

In accordance with another aspect of the present invention, products that are substantially the same, such as with regard to functional features or features with little or no aesthetic component, are decorated with one of a variety of designs that are aesthetically pleasing to the eye of the customer in a virtually limitless number of patterns and motifs. As such, the products, which otherwise are substantially identical and thus are generally sold in the same product line, may nonetheless be differentiated from one another and may appeal to different, distinct, or disparate consumer bases (e.g., different genders, ages, styles, etc.).

In accordance with yet another object of the present invention, distinct decorative elements are provided on products to provide the user with an indication that the user should use the product at a particular time or location or situation. Such indication may further serve as a reminder to replace the product with a new product. The design may be related to time periods generally correlating to natural wear of the product, and thus function as a wear indicator without necessarily evidencing wear of the product.

In one embodiment incorporating one or more principles of the present invention, products are decorated with a design that is readily visible to the user. The design may be provided on a decorative element that is associated with the product, such as a sleeve. The design may serve to differentiate a given product from another substantially identical product differing only in decorative design thereon. Additionally, or alternatively, the decorative design may provide the user with an indication that the user should replace the product with a new product.

These and other features and advantages of the present invention will be readily apparent from the following detailed description of the invention, the scope of the invention being set out in the appended claims.

### BRIEF DESCRIPTION OF THE DRAWINGS

The detailed description will be better understood in conjunction with the accompanying drawings, wherein like reference characters represent like elements, as follows:

FIG. 1 illustrates a set of exemplary products, in the form toothbrushes, each product bearing a different decorative design; and

FIG. 2 illustrates another exemplary set of products, each product being decorated with a design corresponding to a different one of the four seasons of the calendar year.

### DETAILED DESCRIPTION OF THE INVENTION

The principles of the present invention may be applied by various manufacturers wishing to decorate articles or devices (hereinafter “product” or “products” for sake of convenience and simplicity, without intent to limit), such as personal grooming products, in a manner which will be attractive to users and/or which facilitates use of the product. The decorated products may be characterized as designed to perform a useful function (such as combing the hair or brushing the teeth) and having one or more functional features. The principles of the present invention preferably are applied to a product line of products having substantially the same functional features or characteristics, such products being purchased for the functionality provided by such features. Herein, “product line” is defined as products sold by a single company under the same Universal Product Code (UPC) or stock-keeping unit (SKU) and thus products in a given product line are considered, for all intents and purposes, the same product with the same functional features. As such, the products generally have little or no aesthetic component and have essentially the same visual impression or aesthetics. In accordance with the principles of the present invention, a decorative element is provided to permit differentiation among products that are otherwise substantially indistinguishable in a product line so that consumers with different aesthetic tastes looking to purchase a given product for its functional features can nonetheless personalize their choice of product.

For illustrative purposes, the device of the invention as well as methods and apparatus relating thereto may be described, without limitation, with respect to a particular embodiment in the form of a toothbrush, although it will be recognized that the inventive features and concepts are equally applicable to other products. Thus, with reference to the exemplary embodiment of a toothbrush, toothbrushes in a given product line will generally have identical handles, necks, heads, and bristle profiles. More particularly, the functional features of the handle include the shape (such as an ergonomic shape to enhance gripping) and the texture (such as textured or provided with a material, such as an elastomer, to facilitate gripping). The functional features of the head include the shape (such as an elongated or pointed shape to facilitate reaching the back teeth) and the flexibility (such as a flexible head). Bristle profiles are known to have a variety of functional benefits, depending on the particular profile, and gum massagers may be provided to provide functional benefits to complement the function of the bristles. All such functional features are substantially identical among products in a given toothbrush product line, the differences between the products in the product line generally being limited to handle color.

In accordance with one aspect of the present invention, each product of a product line is decorated with one of a variety of patterns, designs, images, symbols, graphics, text, pictures, cartoon characters, lines, geometric shapes, etc. (hereinafter “design” or “designs” for the sake of simplicity, without intent to limit), or any combination thereof. The present invention permits a virtually limitless number of motifs or themes to be used in decorating products. Because consumers often care about how even a primarily functional product looks, the look or style of a product can drive affinity for a particular product line or brand. Sale of a “limited edition” of such product can create even more urgency around the purchase of the designer product, such as to remain fun and current. A consumer's ability to choose among a variety of designs provided on a given product of a product line widens the customer base for such product and/or allows consumers to change/update/refresh the look of the product as often as desired, as will now be described in connection with various exemplary embodiments of various related or independent principles of the present invention.

In accordance with one aspect of the present invention, decorated products, such as personal grooming products, may be sold with one of a variety of different designs. The designs may be provided through the use or application or association of a decorative element with the product, such as by being applied or coupled or integrally formed with the product. It will be appreciated that other manners of decorating a product with a design are within the scope of the present invention. Provision of one of a variety of different designs on a given product in a given product line provides consumers with the option of selecting a product with a design that best suits his/her tastes. At least in the case of disposable products such as adult personal grooming products, such personalization as afforded by the option of choosing a design, rather than merely a color, has not heretofore been available. More particularly, a given type or style or product-line of disposable or relatively low-cost product, such as toothbrushes, pens, hairbrushes, combs, and the like, is generally sold in a one-of-a-kind form (i.e., all such products are substantially identical) or allow for a limited variety among which the consumer may select a preferred product. For instance, products formed of a plastics material such as polypropylene may be formed in a variety of colors, such that a consumer may choose a preferred color. However, such products generally are not formed to provide further personal choices beyond choice of color. In contrast, in accordance with one aspect of the present invention, products that have heretofore only been formed in different colors are now further provided with different designs.

In an exemplary embodiment, a personal grooming product is formed in accordance with principles of the present invention to be decorated with one of a variety of different designs, thereby affording the consumer the opportunity to select one or more preferred designs. Moreover, households with multiple consumers needing to use the same personal grooming product contain duplicates of such personal grooming products. According to one aspect of the present invention, although a plurality of substantially identical products (e.g., substantially functionally identical) are used in a given household, the products are visually differentiated from one another by means other than mere color differences. More particularly, in accordance with one aspect of the present invention, each product bears a design different from the design borne by another product. Consumers thus may choose and identify their individual product by a unique design (among the designs on the plurality of such products in the household) preferably comprising more than one color. Such individualization of the product provides a more complex and unique identifying characteristic than provided by a product formed of a particular single color, or even by a product formed of differently-colored components.

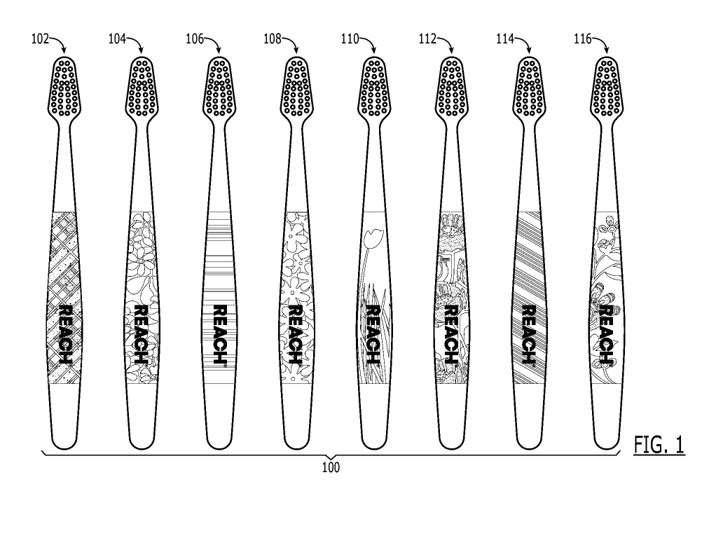

As noted above, a particularly suitable product to which the above inventive concept may be applied is a toothbrush. If the household purchases a multi-pack package containing more than one toothbrush, each member of the household will have a toothbrush that is substantially the same, at least with respect to functional features and basic overall form and appearance (e.g., each toothbrush has essentially the same features, particularly functional features, such as bristle patterns, grips, handle shape, etc.). However, because toothbrushes are personal grooming products, each individual desires to maintain exclusive use of his or her own toothbrush and therefore desires to be able to identify and to differentiate his or her toothbrush from the toothbrushes of the other members of the household. Heretofore, the only variations available for a given toothbrush style or type or product-line have been in the color or colors of the components of the toothbrush (e.g., handle color, or grip color) or selection of one of several graphics in a given theme (e.g., different poses of a given character, or different characters in a particular story or movie, or different characters in a given theme, such as one of several Disney® Princesses). The availability of handles decorated with one of a variety of different designs allows the otherwise identical toothbrushes to be differentiated from one another. However, such variations have nonetheless still been limited to within the same type or theme or class or category, generally appealing to a limited audience or consumer group. For example, even if toothbrushes are decorated with different Princesses, such toothbrush generally appeals to a limited consumer base of young girls and generally will not appeal to young boys, or adults of either gender. In accordance with a more particular aspect of the present invention, the plurality of designs afforded by principles of the present invention are not simply different from one another, they preferably include at least two designs from unrelated, different, disparate, or distinct types or themes or classes or categories (hereinafter “category” or “categories” for the sake of simplicity and convenience, without intent to limit) and thus appeal to a greater variety of consumers (different age groups, genders, artistic styles, etc.). As used herein, a “design category” is to be understood as a type or theme or class or category of design with distinct aesthetic characteristics. Examples of design categories include abstract shapes or geometric patterns (e.g., dots, stripes, plaid, etc.); flowers or other animate objects (e.g., animals, movie characters, cartoon characters, etc.); sport motifs; and/or different color palettes (e.g., one design including blue and black, the other including red, green, and white, with the understanding that black and white often are not considered “colors” and thus may be present in different “categories” of color palettes, and that some overlap is within the scope of the term “different” so long as the different palettes do not share all colors). More preferably, each product in a given set of products may be decorated with one of a plurality of designs selected from more than one design category, wherein at least one of the design categories includes more than one design. For instance, the variety of designs which may be provided for a given toothbrush product line (wherein all toothbrushes are substantially identical, particularly with respect to functional features, except for the decorative feature) may include a first category of striped patterns (e.g., a horizontal stripe pattern and a diagonal stripe pattern), a second category of a variety of floral patterns, and a third category of a plaid pattern, as illustrated in product set 100 illustrated in FIG. 1 and discussed in more detail below. Additional design categories include geometric shapes (either linear shapes or circles or curvilinear shapes such as paisley or fleur-de-lis), seasonal patterns (e.g., snowflakes, beach scenes, etc.), and bi-color patterns (e.g., different patterns in black and white only, or in blue and black only).

As discussed above, the common features of decorated products sold in a given product line that cause the products to be substantially identical (except for the decorative feature) may be the functional aspects or features of the products themselves (in contrast with decorative features or elements). Thus, the present invention also relates to the unique concept of selling under the same UPC or SKU a product that has a given set of features or properties, such as functional characteristics, yet has a variety of visual appearances differentiating one product in that UPC or SKU from another. Traditionally, a UPC or SKU is assigned to a unitary, single-type product. Although minor variations in the appearance of such product (e.g., color, texture, change of scene, or pose of character design) may still fall under the same UPC or SKU, traditionally the products basically have the same general appearance. Even children's toothbrushes decorated with Disney® Princesses (each brush being decorated with a difference Princess) basically fall under the same category, i.e., a toothbrush decorated with a Princess and thus targeting a consumer base of young girls. In accordance with principles of the present invention, articles having common functional features and aesthetic features, such as designs, from unrelated, different, disparate, or distinct categories are nonetheless sold under the same UPC or SKU determined by the common functional features. In accordance with an aspect of the present invention, two or more products sharing the same given set of features or properties, such as functional characteristics, with at least one having a distinct appearance from another, may be sold packaged together and thus under the same UPC or SKU. More particularly, each product in a given product line may be decorated in accordance with principles of the present invention with one of a variety of different designs selected from two or more different design categories. The design categories may be unrelated, thus providing greater variety than previously-offered decorated products. The design categories preferably are unrelated, different, distinct, and/or disparate to appeal to a greater variety of consumers of a greater variety of styles and tastes and/or aesthetic appeals. Preferably at least one design category includes more than one design. More preferably, the variety or set of designs with which a product set may be decorated includes two or more unrelated, different, distinct, and/or disparate design categories, each design category including two or more different designs. Thus, the product line appears to include products from disparate categories from an appearance perspective, since the designs on the products may be from distinct, disparate, different, and/or unrelated categories. Because the differently decorated products all share substantially the same functional features, the products nonetheless are appropriately sold under the same UPC or SKU.

In accordance with a related aspect of the present invention, principles of the present invention may be applied to products of a given product line sold under the same SKU or UPC to refresh the decorative aspects of the product line while maintaining the functional aspects, and thus allowing the product line to maintain the same SKU or UPC. Generally, retailers will only allow the same product type to be sold under a given SKU or UPC. Principles of the present invention may be applied to alter merely a decorative element associated with the products in a product line, thereby maintaining the characteristics required for the product line to be sold in the same SKU or UPC of its predecessor products, while nonetheless allowing a “refresh” of the product line. The decorative element associated with the products of the product line may be changed such as to follow fashion trends, seasons of the calendar year, holiday themes, or simply to provide consumers with a new set of designs to choose from. By changing the decorative element associated with products of a given product line without changing the other characteristics, particularly the functional characteristics of the products of the product line, consumers are afforded more stylistic options. Moreover, the manufacturer may change the decorative elements periodically to encourage consumers to purchase the “latest” design. Consumers will begin to know to look for the design change in the product line, and will be encouraged to purchase a new product when such change occurs. A change in the product line designs may also indicate to the consumers that it is time to replace the product in accordance with recommended replacement protocol.

The principles of the aspect of the present invention relating to products bearing designs from distinct, disparate, different, and/or unrelated categories may be combined with the earlier-described aspect of the present invention relating to decorating substantially identical products of a given product line with different designs (beyond mere color differences) to permit individuals of a household to differentiate their products from that of the other household members. In particular, it may be particularly advantageous to package a plurality of decorated products of the same type, wherein the designs on the products are selected from two or more distinct, disparate, different, and/or unrelated categories. For example, a product set 100 of a plurality of toothbrushes 102, 104, 106, 108, 110, 112, 114, and 116, as shown in FIG. 1, may be decorated with designs of at least two distinct, disparate, different, and unrelated categories. In the exemplary toothbrush set 100 of FIG. 1, designs 102, 106, and 114 are abstract or geometric or linear, whereas designs 104, 108, 110, 112, and 116 are floral or organic. If toothbrushes of set 100 are sold individually under the same UPC or SKU, then consumers desiring to purchase that particular toothbrush (with a given set of functional characteristics) have the option of choosing among one of a plurality of different aesthetic designs. If a multi-pack containing two or more toothbrushes of set 100 is sold to a single consumer, then the consumer may refresh the “look” of his or her toothbrush periodically upon replacing one toothbrush from set 100 with another toothbrush from set 100. Or, if a multi-pack containing two or more toothbrushes of set 100 is sold to a household with more than one consumer, then the consumers may distinguish their toothbrushes from one another based on the unique aesthetic design on each of the different toothbrushes in the multi-pack. If desired, one or more toothbrushes of a plurality of different, distinct, disparate, and/or unique categories may be provided in a multi-pack, such as a “family” pack for a family with a man and a woman, and possibly also children old enough to use “adult” toothbrushes. The different categories in such a “family” pack thus preferably would include a male-oriented design category, a female-oriented design category, and one or more “young adult” design categories (possibly further subdivided by gender).

It is desirable to manufacture and to decorate products in a manner that is economical yet which still provides the greatest flexibility. An exemplary manner of decorating products with different designs that is considered to be economical and relatively simple is the application of a substrate bearing the design to the product. One such method involves heat-shrinking a tubular plastic film over a portion of a product to conform to the shape of the product and thereby to adhere the design on the film to the product so that the product is thereby decorated, as described in further detail below. In the case of manufacturers selling multi-packs, it is easier to make multi-packs with several designs on the same roll of film. The manufacturer could use the same number of colors, but change out the patterns/designs to form a multitude of patterns that can be sold in multi-packs.

It will be appreciated that products to be decorated in accordance with principles of the present invention may be formed from material that is not a single color. Instead, the common product to which a variety of designs are to be applied in accordance with principles of the present invention may be made in a variety of colors. For example, the product may be made of more than one component (such as a handle, a grip element, and bristles, in the case of a toothbrush), each component potentially being a different color. Moreover, if various-colored products are processed in a random order for application of a design thereto (as will be described in further detail below), one of the varieties of available designs may be applied to a random-colored product, thereby increasing the variety of different appearances the otherwise substantially identical products may have. In other words, a variety of product colors and a variety of aesthetic designs may be randomly matched, thereby increasing the available varieties of appearances of the product.

In accordance with a further aspect of the present invention, the various aesthetic designs applied to a given product may be formed to blend or otherwise to be compatible with other visual properties or aesthetics of the product. For instance, the design may be configured to look like it is integrally formed on the product, rather than provided on a separate element that is coupled to the product. In one exemplary embodiment, the design may include the main color of the product to which the design is applied in such a manner that the design appears to be printed directly on the product or otherwise continuous with the product, rather than formed separately from (and later applied to) the product, such as in a form as a sleeve or appliqué. An example of color matching to achieve an integrated effect is illustrated in the exemplary embodiment of FIG. 1. The basic color of the exemplary toothbrushes of set 100 is white, and the design applied to each of exemplary toothbrushes 102, 104, 106, 108, 112, and 116 may include a sufficient amount of white such that the other colors of the design appear to be applied directly to the white toothbrushes, rather than including white as another color. Other manners of color-matching between the product color and one or more colors in the design to be applied to the product are within the scope of the present invention as well. For instance, the set of designs to be applied to a given product set may be selected to work aesthetically with other features of the product to achieve design continuity or at least a complementary visual effect.

In summary, for ease of manufacturing, for example, manufacturers could produce products in one of four different colors and apply to those colored products designs that work with or complement the product colors. Multi-packs, or value-packs, could be sold with a variety of product colors and a variety of designs randomly applied to the colored products, giving the consumers much more personalized choice of the designs that they prefer. One exemplary embodiment incorporating one or more of the above-described principles of the present invention is the sleeving of a given set of adult toothbrushes with sleeves decorated with one of a variety of different designs. Thus, a variety of age groups (tweens, teens, young adults, middle-aged adults, and seniors) as well as different genders of individuals who each prefer a particular style toothbrush may express their personal taste when choosing or purchasing toothbrushes with a given set of functional properties by choosing a design on such toothbrush that suits their own personal taste, style, aesthetics, etc.

It will be appreciated that other features may be provided on products decorated in accordance with principles of the present invention to permit personalization and/or individualization of products with otherwise substantially identical features. For example, principles of the present invention may be applied to provide customizable designs (i.e., images/patterns/moods/etc.) and/or personalization such as in the form of printing or labels that may be applied by the consumer to the product. For example, decorative elements such as decals, stickers, labels, or “skins” (such as used on products such as cellular telephones) may be provided with the decorated product so that consumers may create further customizable designs (i.e., images, patterns, moods, etc.) by themselves placing the decorative elements on the product.

Designs provided on products of a given product line in accordance with principles of the present invention may be further enhanced to provide other benefits. For instance, hand-held products, such as toothbrushes, often are provided with gripping elements, such as rubberized grips or gripping pads. If such products are decorated by applying a decorative element such as a sleeve over a portion of the product, then the decorative element may cover a grip element. Although it may be desirable to cover a grip element with a decorative element (to impart a softer surface than would be provided if the decorative element were provided over a harder surface), certain functions of the grip element, such as a non-slip feature, would no longer be available to the consumer. In accordance with yet another aspect of the present invention, a non-slip grip material may be applied to a decorative element on which a design is provided and which is provided on a product to decorate such product. Because such non-slip grip material typically is applied by a different process than used to print the design (such as through the use of a spray cylinder that sprays the non-slip material in a given pattern), provision of such non-slip grip material increases production steps and, therefore, also increases production costs. In accordance with principles of the present invention, the grip material may be applied in a pattern that complements the various designs to be applied to the product. In other words, a single grip material pattern may be used which blends with or at least complements all of the designs to be used on the products of the product line, thereby simplifying the grip-material application process to a single process performed on all of the different designs for a give product line. In an embodiment of the invention in which the products to be decorated are toothbrushes, and the decorative element is a tubular sleeve to be applied over the toothbrush handle, sleeves may be formed in multiple designs, all carried on a single roll of material on which the various designs have been printed. That roll of material may be processed in the same grip-material-applying process if the grip-material pattern complements each of the various designs. Or, the grip material may be of an uncolored material which may be applied regardless of the color scheme and/or pattern of a given design to which the grip material is to be added. Of course, variation in grip pattern or texture may be a further decorative element differentiating otherwise substantially identical products from one another by design feature only. It will be appreciated that such gripping features may be applied to products other than toothbrushes that are differentiated by their different designs in accordance with principles of the present invention.

In accordance with yet another aspect of the present invention, products may be formed with other aesthetic variations beyond decorative designs to permit consumers choices among otherwise substantially identical products. For instance, color variations not previously offered may be used in addition or alternatively. With respect to the exemplary embodiment of toothbrushes, the bristles may be colored in different patterns or schemes so that each toothbrush in the product line has differently colored bristles, while the bristles still have substantially the same functional characteristics. Other examples of aesthetic variations include different fragrances (e.g., incorporated into the material of the product, or in a decorative element bearing a design to be applied to the product) or material types that may be used to further differentiate the otherwise identical (at least functionally) products. If desired, materials with unique properties, such as color changing plastics (such as in dolls that have patterns that appear when the doll becomes wet), or glow in the dark materials, may be used to afford further differentiation. Additionally or alternatively, special inks may be used to form designs used to differentiate otherwise identical products, such as by being heat-sensitive to change color, or to appear/disappear. Decorative elements may also provide further features, such as to indicate time to change or to replace the product with a new product, such as provided by wear indicators (e.g., inks or materials that change color over time). For instance, color changing plastics may change color in a manner that provides a time cue while in use/brushing, or as a signal to throw out and replace the toothbrush, or to signal that the user is brushing too hard or gripping the toothbrush too hard.

In accordance with another aspect of the present invention, which may be considered related or separate and independent, different designs to be applied to products that otherwise are substantially identical and belong to the same product line may themselves be indicators for changing or replacing the product. For instance, the different, distinct, disparate categories of designs for a given set of products may be different chronological themes (e.g., daily, monthly, seasonal, time of year, or even time of the day—AM vs. PM). With respect to seasonal themes, although the designs are all commonly “seasonal,” each season is its own unique category such that the theme of each design differs from that of the other designs in the pack. More particularly, four (or another number, or a multiple thereof, e.g., eight or twelve) products may be sold together in a single package, each product in each set of four products bearing, in accordance with principles of the present invention, a design associated with a different season (Spring, Summer, Autumn, Winter). The products may differ only in the seasonal decoration or design thereon. Because a given package contains a product for each season, a consumer can purchase the package at any time during the year and have available a product for the particular season in which the package was purchased, and also have sufficient products to last for the remainder of the year. For example, if the consumer purchases the package during the Spring season, the consumer would use the product with the “Spring” design until the Summer season, at which time the consumer would replace the “Spring” product with the product with the “Summer” design, and so forth.

As may be appreciated, provision of a set of products decorated with different seasonal themes may serve an additional purpose beyond mere decoration—the design may serve as a reminder to replace the product with another product once a new season begins. Such concept is particularly suitable for products that should be replaced approximately every three (3) months, a unit of time generally corresponding to a season. One type of product to which the invention may be advantageously applied is toothbrushes, because it is recommended to replace toothbrushes every three months as they begin to wear out. The sale of a package of four toothbrushes, each decorated with a different seasonal theme, is particularly advantageous because the consumer can purchase a one year supply and have a replacement reminder system automatically provided on the toothbrush itself. The design provided on each toothbrush serves the dual purpose of decoration as well as an indicator that signals the user to replace the toothbrush when the seasonal design on the toothbrush no longer corresponds to the actual season in which the toothbrush is being used. Packages of multiples of four (e.g., eight, twelve, sixteen, etc.) toothbrushes may be sold for households with more than one individual. Applying the earlier-described principles of individualized decorated toothbrushes, each set of four seasonally-decorated toothbrushes preferably contains a design for each season different from the design of the other sets of four seasonally-decorated toothbrushes. In other words, greater than one design may be provided for each season to allow for different consumer preferences.

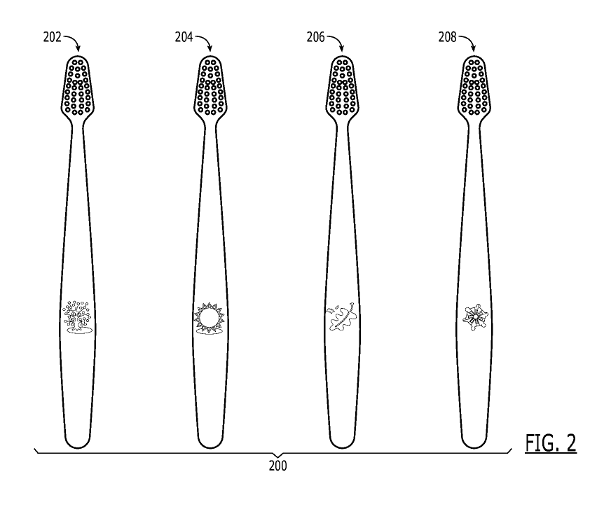

An exemplary illustration of a seasonally-decorated set of toothbrushes is provided by FIG. 2, showing an exemplary set 200 of four toothbrushes (202, 204, 206, and 208) with four different designs, each design selected from one of four distinct seasonal themes, each seasonal theme coinciding with one of the four seasons of the calendar year. The design of toothbrush 202, a tree with budding leaves, has a “Spring” pattern. Toothbrush 204, with a sun, has a “Summer” pattern. On toothbrush 206, falling leaves are an “Autumn” pattern, while toothbrush 208 has a snowflake, or “Winter” pattern. It will be appreciated that seasonal themes need not be limited to Spring, Summer, Autumn, and Winter. Instead, seasonal themes may indicate another type of season, such as a holiday season, or seasonal events. Examples of other types of seasonal (or time of year) themes include, without limitation, Easter or flowers (corresponding to the Spring season) or the start of baseball season (generally in the Spring); fireworks, beaches, the sun, sunglasses or the like (corresponding to the Summer season); the start of school (a pencil or notebook or other school-theme corresponding to the Autumn season in which school typically begins) or football season (generally in the Autumn); and Christmas/Chanukah/New Years (three months after the start of school and corresponding to the Winter season) or winter sports (e.g., skiing, ice skating, ice hockey, etc.). It will be appreciated that the toothbrushes can be sold individually, preferably with a variety of designs provided for one or more seasonal themes. The earlier described inventive feature of providing under the same UPC or SKU substantially functionally identical devices or articles decorated with designs from separate themes may be applied to the inventive feature of seasonally-decorated articles or devices, as may be readily appreciated.

It will be appreciated that the concept of customization of products of a given product line by decorating the products with one of a variety of designs may also be to correlate the product to another related product or product line. For instance, in the example of toothbrushes, the designs applied to the toothbrushes may be graphics corresponding to another oral care product, such as a dental floss, or a mouth rinse, or toothpaste. More particularly, the designs may be selected to correspond to the different flavors of mouth rinses (e.g., a peppermint leaf, a cinnamon stick, an orange, a eucalyptus leaf, or other images corresponding to ingredients or flavors). Patterns on the personal grooming devices can use patterns that match other products in a line of related products. For example, a company that manufactures combs, brushes, hair dryers, curlers, etc., can use patterns on the comb and/or brush handles that match the designs of the hair dryers and/or curlers.

The various stages in the fabrication of an exemplary decorated product in accordance with principles of the present invention are described in U.S. Published Patent Application No. 2003/0028987, herein incorporated by reference in its entirety. In brief, a tube of heat-shrinkable plastic film having a decorated pattern thereon is positioned about at least a portion of the handle of the toothbrush body such that the portion of the handle is contained within the interior region of the tube. Materials that may be used for the film include, but are not limited to, resins such as polyethylene terephthalate (PET), glycol-modified polyethylene terephthalate (PETG), polyvinyl chloride (PVC), oriented polystyrene (OPS), or polylactic acid (PLA). In some embodiments, PET or PETG are used. The tube of film has an internal cross-sectional area that is sufficiently large to permit the film to be easily positioned around the handle, and sufficiently small such that when the film is subjected to heat-shrinking, it comes into conforming contact with all desired portions of the toothbrush body. For the designs to be delivered properly, they need to be designed to shrink to the object they are conforming to and deliver the right clarity in the image. Typically, such films undergo a degree of shrinkage of up to about sixty (60) percent in the circumferential direction when subjected to heat shrinking Once the tubular film has been positioned on the toothbrush handle, it is then heated to a temperature and for a period of time sufficient to cause the film to shrink into conforming contact with the toothbrush handle. Typical range of heat to be applied begins (low end) in the following ranges, depending on material dimensions and thickness. For PVC, PETG, OPS (petroleum based resins) this is typically between 140° F. and 190° F., while for PLA it is typically between 130° F. and 140° F. In one embodiment, the process could be done manually, with the film taking only a few seconds to shrink. In an alternate embodiment, an automated line could be used. Here, the line take the roll of sleeves, applies them to handles, and sends the handles through a heat tunnel to shrink the sleeves on to the handle. A typical process could use: 1) Range of Heat: 240° F. to 325° F., 2) Duration of Heat: about 18 Seconds 3) Duration of Cooling: about 6 Seconds. When automated, the brushes go through at a controlled speed and temperature.

As noted above, the use of sleeving allows manufacturers the capabilities of changing the visual takeaway and elements of the variety of designs to be applied to a given product line. Changing designs is easily and cost-effectively implemented. Also, the number of design options afforded by sleeving enables multiple differently decorated products to be provided during the same sleeving process. Sleeving also may allow for various process improvements, such as by simplifying the packaging of multi-pack packages. For instance, if the sleeves are formed from a single roll of sleeve material, the sleeve material may be decorated with a plurality of different designs, thus permitting continuous streamlined decorating of products with one of a variety of different designs. As noted above, if the underlying product is provided in a plurality of different colors, which are randomly processed for application of a sleeve thereto, then the number of different resulting decorated products is increased beyond the number of different available sleeve designs.

### EXAMPLES

The inventive devices and methods will now be illustrated by way of the following non-limiting examples:

### Example 1

A conveyor is fitted with a plurality of fixtures, each of which releasably engages a toothbrush body. Each fixture positions a shrinkable tubular film in a desired longitudinal position along the handle of a toothbrush prior to the heating. Tubular films comprised of, for example, Eastar PETG Copolyester 6763 poly(ethylene-1,4-cyclohexylenedimethylene terephthalate), and decorated with a “spring” decoration (as show in toothbrush 202 in FIG. 2), are positioned around each fixtured toothbrush handle such that the handle is contained within the interior region of the tubular film. The resultant toothbrush bodies containing the tubular film positioned thereon are conveyed to a heating station comprising contiguous heating zones. Each zone contains a forced air heater which directs hot air at the tubular film positioned about each toothbrush body. The two zones are configured to direct the heated air asymmetrically to the bottom of the brush and symmetrically to both the top and bottom faces of the toothbrush handle. After emerging from the heating station, the shrinkable tubular film is in conforming contact with the toothbrush body, with minimum distortion of the decoration on the toothbrush handle. Following passage through the heating station, the resultant decorated toothbrush bodies are allowed to cool and were removed from their fixtures. The decorated toothbrush bodies are then bristled using conventional bristling technology well known in the art, and collected in a bin marked “Spring.”

The above process is repeated with a “summer,” “fall,” and “winter” decoration (as show on toothbrushes 204, 206, and 208, respectively, in FIG. 2), and, after bristling (attachment of bristles) are collected in bins marked “Summer,” “Fall,” and “Winter,” respectively.

For packaging, a “4-pack” of toothbrushes is created by selecting one toothbrush from each bin, i.e. one toothbrush from the bin marked “Spring”, one from the bin marked “Summer”, one from the bin marked “Fall”, and one from the bin marked “Winter”, and packaging the four toothbrushes in a single “4-pack” for future sale.

### Example 2

A conveyor is fitted with a plurality of fixtures, each of which releasably engages a disposable razor body. Each fixture positions a shrinkable tubular film in a desired longitudinal position along the handle of a disposable razor prior to the heating. Shrinkable tubular films decorated with the word “JAN” are positioned around each fixtured disposable razor handle such that the handle is contained within the interior region of the tubular film. The resultant disposable razor bodies containing the tubular film positioned thereon are conveyed to a heating station comprising contiguous heating zones. Each zone contains a forced air heater which directs hot air at the tubular film positioned about each disposable razor body. The two zones are configured to direct the heated air asymmetrically to the bottom of the brush and symmetrically to both the top and bottom faces of the disposable razor handle. After emerging from the heating station, the shrinkable tubular film is in conforming contact with the disposable razor body, with minimum distortion of the decoration on the disposable razor handle. Following passage through the heating station, the resultant decorated toothbrush bodies are allowed to cool and were removed from their fixtures. The decorated disposable razor bodies are then collected in a bin marked “January.”

The above process is repeated with a “FEB,” “MAR,” “APR,” “MAY,” “JUN,” “JUL,” “AUG,” “SEP,” “OCT,” “NOV,” and “DEC,” decoration, and the disposable razors are collected in eleven different bins marked “February,” through “December.”

For packaging, a “12-pack” of disposable razors is created by selecting one disposable razor from each bin, i.e., one disposable razor from each of the twelve bins, and packaging the four toothbrushes in a single “12-pack” for future sale.

It will be appreciated that devices formed in accordance with principles of the present invention, particularly combs and toothbrushes, are typically used in moist environments. As such, there is the possibility of liquid seeping between the decorative element (if applied separately to the product) and the product. Liquids trapped between the decorative element and the product may provide a breeding ground for bacterial growth. Accordingly, it is preferable that the decorative elements applied to products in accordance with principles of the present invention are vapor permeable to permit any liquid that might seep between the decorative element and the product to permeate through the decorative element and away from the product when the product is not in use. Alternatively, the decorative element or the product may be treated with an antibacterial agent or the like to retard bacterial growth.

While the foregoing description and drawings represent exemplary embodiments of the present invention, it will be understood that various additions, modifications and substitutions may be made therein without departing from the spirit and scope of the present invention. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. For example, elements shown as integrally formed may be constructed of multiple parts or elements shown as multiple parts may be integrally formed, the operation of elements may be reversed or otherwise varied, the size or dimensions of the elements may be varied. The presently disclosed embodiments are therefore to be considered in all respects as illustrative and not restrictive, the scope of the invention being indicated by the appended claims, and not limited to the foregoing description.

What is claimed is:

1. A decorated toothbrush comprising:
a handle having proximal and distal ends, a neck and a head;
bristles attached to said head; and
a decorative pattern on at least a portion of one of said handle, said neck, and said head;
wherein said decorative pattern provides the user with an indication that the user should replace said toothbrush with a new device.

2. A decorated toothbrush as in claim 1, wherein said decorative pattern is representative of an event beginning at a specific time of the calendar year, one of the four seasons of the calendar year, a seasonal occasion, or a holiday.

3. A decorated toothbrush as in claim 2, wherein said toothbrush is one of a plurality of toothbrushes, the others of said plurality of toothbrushes having different decorative patterns.

4. A decorated toothbrush as in claim 1, wherein said decorative pattern is provided on a plastic film in conforming contact with at least a portion of said handle.

5. A method of selling products in a product line, said products all having substantially the same functional characteristics and features, said method comprising:
decorating each product in said product line with a design from one of at least two design categories;
wherein:
said design categories are different from one another to appeal to different and disparate consumer bases; and
at least two design categories contain at least two different designs.

6. A method as in claim 5, further comprising selling at least two said products in a single package, each product having a different design thereon.

7. A method as in claim 5, further comprising selling two said products in a single package, wherein a first of said products has a design selected from more than one design in a first design category, and a second of said products has a design selected from more than one design in a second design category.

8. A method as in claim 7, further comprising varying the contents of said single package such that a plurality of packages are sold with different combinations of designs from said first and second design categories.

9. A plurality of packages of products having substantially the same functional characteristics and features, said products each having an associated decorative element, wherein:
each said associated decorative element is selected from one of a plurality of different design categories;
said design categories are different from one another to appeal to different and disparate consumer bases;
at least two of said design categories include at least two different designs; and
at least two packages contain products with different designs.

10. A plurality of packages of products as in claim 9, wherein:
said at least two packages each contain at least two products; and
each product in a first of said at least two packages has decorative elements different in design from the decorative elements on each product of a second of said at least two packages.

11. An adult toothbrush product line, each adult toothbrush in said product line comprising:
a handle;
a toothbrush head with bristles for cleaning adult teeth; and
a decorative sleeve covering at least a portion of said handle;
wherein said decorative sleeve bears a design selected to appeal to adults.

12. An adult toothbrush product line as in claim 11, wherein said product line includes a plurality of different designs, wherein said designs belong to two or more different design categories, at least two of said design categories including at least two different designs.

13. A method of decorating products of a product line, said method comprising:
associating with each of said products of said product line one of a plurality of designs from a set of designs; and
changing said set of designs on a periodic basis to refresh said product line.

14. The method of claim 13, wherein said set of designs includes at least two categories of different, disparate, distinct, or unrelated design categories to appeal to different, disparate, distinct, or unrelated consumer bases.

15. The method of claim 13, further comprising changing said set of designs more than once per year.

16. The method of claim 15, further comprising changing said set of designs to a different set of designs at least every four months.
